(19) United States
(12) Patent Application Publication
(10) Pub. No.: US 2012/0204402 A1
(43) Pub. Date: Aug. 16, 2012

(54) METHOD AND APPARATUS FOR MANUFACTURE OF COVERED STENTS

(76) Inventor: Ismet Seel, Hechingen (DE)

(21) Appl. No.: 13/202,754

(22) PCT Filed: Jan. 27, 2010
(86) PCT No.: PCT/EP2010/000484

§ 371 Date: Mar. 23, 2012

Related U.S. Application Data
(60) Provisional application No. 61/148,011, filed on Jan. 28, 2009.

(51) Int. Cl. B23P 11/00

(52) U.S. Cl. 29/428; 29/33 R

(57) ABSTRACT

The present disclosure is directed to an apparatus (100) for applying a graft material to a stent. (4) The apparatus may include a hollow mandrel (3) adapted to receive a stent. The mandrel (3) may include apertures adapted to allow a vacuum to be applied in order to temporarily affix the graft material sheath (20) to the stent. A forming roller (8) lying axially parallel to and in contact with the stent (4) may be included. Rotation of the forming roller may rotate the stent about its longitudinal axis. A second roller (9) for applying the sheath (20) of graft material to the stent as the stent (4) is rotated about its axis may be included. Further, the present disclosure is directed to a method of manufacturing stent grafts.

### BACKGROUND OF THE DISCLOSURE

The present disclosure relates generally to providing apparatus and methods for covering medical stents. In particular, the present disclosure relates to improved apparatus and methods for applying a cover sheath to a medical stent to provide a stent graft.

### BRIEF SUMMARY

The present disclosure relates to apparatus and methods for applying a cover sheath to a medical stent to provide a stent graft. In particular, the disclosure relates to a semi-automated but optionally hand operatable apparatus to apply a cover to a medical apparatus, such as a stent. Embodiments of the present disclosure may facilitate effectively and/or precisely applying a cover sheath to a medical stent.

Stent grafts are typically used for supporting of vessels, in particular in the case of aneurisms and also in the case of labile or brittle or thrombotic vessels.

Conventional stent grafts typically include a radially expanding stent that is produced, for example, by laser cutting metal tubes and attaching a coating or cover sheath to the stent. The coating and/or cover sheath that may include a fabric and/or foil. The coating may limit blood passage or passage of blood components or deposits through the wall of the stent graft and/or may limit tissue growth through the wall into the interior of the stent graft. Thereby, the vessel wall may have reduced pressure. Embolic formation may be reduced or prevented at the implementation point of the stent graft.

The cover or coating may be of tubular shape with the tube diameter generally corresponding to the dimensions of the stent to which the cover will be attached. In some embodiments, the cover may be made from a flat sheath of covering and/or graft material which may be wrapped around the stent. In some embodiments, the wrapping can be performed in a single layer, a dual layer, multiple layers in thickness, or combinations thereof depending on the graft material and/or the specific needs for the resulting stent graft.

As the graft material sheath is wrapped over the stent precision may necessitate (i) precisely placing the graft material on the stent, (ii) tightly fitting the stent and the graft material, (iii) avoiding folds and/or crinkles, (iv) other considerations, or (v) combinations thereof. Further, the placement of the graft material sheath may be time-consuming and/or may usually be performed by hand-operation. Also, as stent grafts may have dimensions as small as about 5 mm in length and/or about 1 mm in diameter, the handling of the sheath and/or stent may be very cumbersome.

It may therefore be desirable to provide apparatus and methods for applying a cover sheath to a medical stent to provide a stent graft.

According to the present disclosure, an embodiment of an apparatus for applying a graft material to a stent is provided. The apparatus may include,
(a) a mandrel adapted to receive the stent within the apparatus,
(b) a forming roller lying axially parallel to and in contact with the stent, whereby rotation of the forming roller rotates the stent about its longitudinal axis,
(c) mechanical means for applying a sheath of graft material to the stent as the stent is rotated about its axis,
(d) mechanical means for synchronising the rotation of the stent with the means for applying the graft material, the stent receiving mandrel may be a hollow tube provided with small apertures in the region of the receiving area of the stent to allow a vacuum to be applied in order to temporarily affix the graft material sheath to the stent once the graft material came into contact with the stent, or combinations thereof.

The means for applying the sheath of graft material to the stent may include a pressure roller lying axially parallel to the stent and/or arranged to press the sheet slot against the stent. The sheath of graft material may be in the form of pre-cut sheath that can be fed manually into the pressure roller.

The means for synchronising the rotation of the stent with the means for applying the sheath of graft material to the stent may be provided by intermediate gearing means in operative cooperation with the forming roller. In one embodiment, the stent on the stent receiving mandrel itself may operate as means for synchronizing the rotation of the stent with the means for applying the sheath of graft material to the stent.

The stents used as the frame for the stent graft for use by the apparatus of the disclosure may be balloon expandable and/or self expandable. Suitable materials for forming these stents may include stainless steel, cobalt-chromium alloys, or Nitinol in case of self-expandable stents. Other metals, alloys, polymers, composites, plastics, other materials, or combinations thereof may be possible.

The cover or coating can be affixed to the stent in many different ways including gluing, sewing, folding around the stent, other ways, or combinations thereof. In one embodiment, as depicted in U.S. Pat. No. 5,916,264, the disclosure of which is hereby incorporated by reference in its entirety, the stent graft may include two coaxially arranged radial extending stents, and a flexible, stretchable material layer, such as a cover sheath, may be provided between both stents, and thus may be clamped between the two coaxially arranged stents.

Cover materials suitable for use by an apparatus according to the present disclosure may include flexible sheaths and/or foils of woven and/or knitted materials, such as but not limited to polyethylene terephthalate and/or of porous polytetrafluoroethylene (hereinafter PTFE). Grafts of biological origin may alsobe used, like biological materials with autologous or homologous veins or arteries, these being typically fixed human umbilical or bovine arteries. Other materials may be used to form the sheath, foils, webs, or other structures forming the cover material. For instance, other metals, alloys, polymers, plastics, composites, other materials, or combinations thereof may be used.

A PTFE foil may be used that has a fibril structure and is unidirectionally expandable and thus can undergo radial expansion where the typical PTFE graft material is usually co-axially placed over the stent when the stent is implanted into the vessel by, for example, balloon expansion.

To produce the sandwich construction stent graft depicted in U.S. Pat. No. 5,916,264 a sheath of, for example, PTFE foil may be wrapped around a first stent resulting in a two to three layered PTFE cover around the first stent. Subsequently, the second stent may be disposed over the first stent and the cover material and may be affixed to the first stent to result in the sandwich stent graft.

These and other objects and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only illustrated embodiments of the disclosure and are therefore not to be considered limiting of its scope. The disclosure will be described and explained with additional specificity and detail through the use of the accompanying drawings in which:

FIG. 1 is a partial cutaway perspective view of an apparatus according to the disclosure.

FIG. 2 is a rear perspective view of an apparatus according to the disclosure.

### DETAILED DESCRIPTION

The present disclosure is directed to apparatus and methods for applying a cover sheath to a medical stent to provide a stent graft. More specifically, at least one embodiment of the present disclosure is directed to apparatus and methods for wrapping a sheath of graft material over a stent, thereby ensuring precise location of the cover material and a tight fit of the material to the stent.

An embodiment of the present disclosure is further directed to a apparatus for applying a graft material to a stent, the apparatus including,
(a) a mandrel adapted to receive the stent within the apparatus,
(b) a forming roller lying axially parallel to and in contact with the stent, whereby rotation of the forming roller rotates the stent about its longitudinal axis,
(c) mechanical means for applying a sheath of graft material to the stent as the stent is rotated about its axis, and
(d) mechanical means for synchronising the rotation of the stent with the means for applying the graft material, the stent receiving mandrel being a hollow tube provided with small apertures in the region of the receiving area of the stent to allow a vacuum to be applied in order to temporarily affix the graft material sheath to the stent once the graft material came into contact with the stent, or combinations thereof.

In one embodiment, the means for applying the sheath of graft material to the stent may include a pressure roller lying axially parallel to the stent and arranged to press the sheath of graft material against the stent. The sheath of graft material may be in the form of pre-cut sheath that can be fed manually into the pressure roller.

In a further embodiment, the means for synchronising the rotation of the stent with the means for applying the sheath of graft material to the stent may be provided by intermediate gearing means in operative cooperation with the forming roller.

In one embodiment, the stent on the stent receiving mandrel itself may operate as means for synchronising the rotation of the stent with the means for applying the sheath of graft material to the stent by contacting both means.

Another embodiment of the present disclosure is further directed to a method for manufacturing a stent graft, the method including:
a) providing an apparatus having a hollow mandrel adapted to receive a stent, the mandrel having apertures in the region where the stent is imposed on the mandrel;
b) providing a stent;
c) imposing the stent on the mandrel;
d) applying a vacuum to the inside of the mandrel;
e) providing a sheath of a graft material of a size suitable to cover the stent in the desired area;
f) contacting a first portion of the graft material sheath with the outer surface of the stent mounted on the mandrel, thereby creating a tight temporary fit between the first end of the graft material and the stent by the drawing force of the vacuum; and
g) wrapping the graft material around the outer surface of the stent by rotation of the mandrel with the stent imposed thereon, or combinations thereof.

In one embodiment, the method further includes affixing the wrapped graft material to the stent. In a further embodiment, the wrapped graft material may be affixed to the stent by the superimposition of a second stent over the first stent and the graft material. In further embodiments, the graft material can also be affixed to the stent by, for example but without limitation, gluing, sewing, folding, or combinations thereof around the stent, and/or by imposing cuffs, rings, zigzag formed crowns, or combinations thereof over the stent and/or graft material ends to clamp the ends of the graft material onto the stent.

In a further embodiment, the method for wrapping a sheath of graft material over a stent may include releasing the vacuum and/or removing the stent graft from the mandrel.

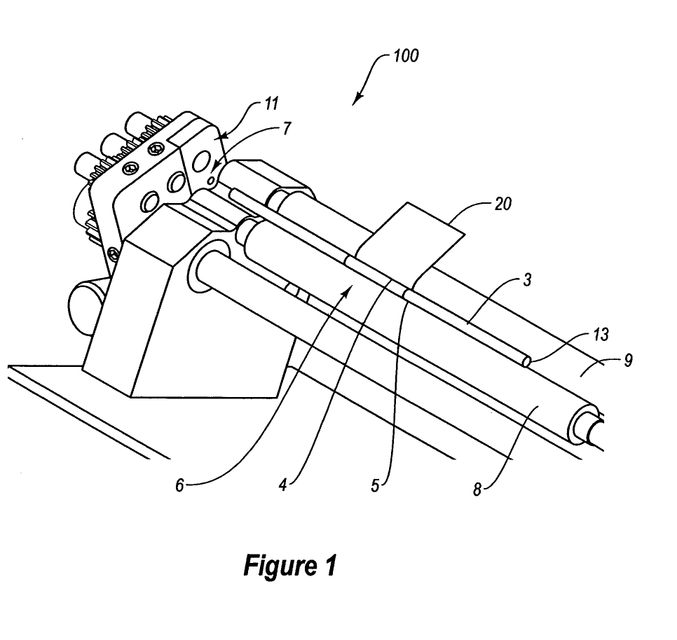

Referring now to FIG. 1, there is shown an embodiment of an apparatus 100 according to the present disclosure. A mandrel 3 may be adapted to receive a stent 4 and/or may be made from a hollow tube with apertures 5 in the region of the receiving area 6 of the stent. The mandrel 3 may be loosely positioned in the apparatus in FIG. 1. The mandrel may be air tightly affixed to the connection port 7 in the apparatus which may be connected to a vacuum pump (not shown) for generation of a vacuum or at least a very low pressure in the mandrel. On the mandrels end opposite to the connection port, the mandrel may be closed and/or sealed with a plug 13.

A forming roller 8 may be axially parallel to and/or in contact with the stent 4 on the mandrel 3. Rotation of the forming roller 8 may rotate the stent 4 about its longitudinal axis. Mechanical means for applying a sheath of graft material to the stent as the stent is rotated about its axis may include a second roller 9 that may be parallel to the stent 4 on the mandrel 3. In one embodiment, and as shown in FIG. 1, mechanical means for synchronising the rotation of the stent with the means for applying the graft material are provided. An example of means for synchronising the rotation of the stent with the means for applying the graft material may include gear configuration 11. In another embodiment, these means may be provided by the close contact between each of the two rollers 8, 9 and the stent 4 on the mandrel 3. It will be understood that the two rollers 8, 9 may be arranged parallel to each other without touching each other.

As further shown in FIG. 1, a sheath of graft material 20 of a predetermined size suitable to cover the stent 4 to be covered may be inserted for operation of the apparatus into the inter-space between the second roller 9 and the stent 4. Air flowing through the apertures 5 in the mandrel 3 may be effected by the vacuum drawn inside the mandrel 3. The graft material 20 may be releasably attached to and/or adducted to the stent 4 affixed to the hollow mandrel 3. This adduction may facilitate a more precise location and/or tighter fit of the graft material 20 to the outer surface of the stent 4.

Activation of the apparatus 100 may initiate the rotation of the forming roller 8. The rotation of the forming roller 8 may rotate the stent 4 about its longitudinal axis. The mechanical means for applying the sheath of graft material 20 to the stent or roller 9 may be rotated by the forming roller 8. The second roller 9 may be rotated and may feed the graft material 20 onto the rotating stent 4, thus wrapping the graft material 20 around the outer surface of the stent 4.

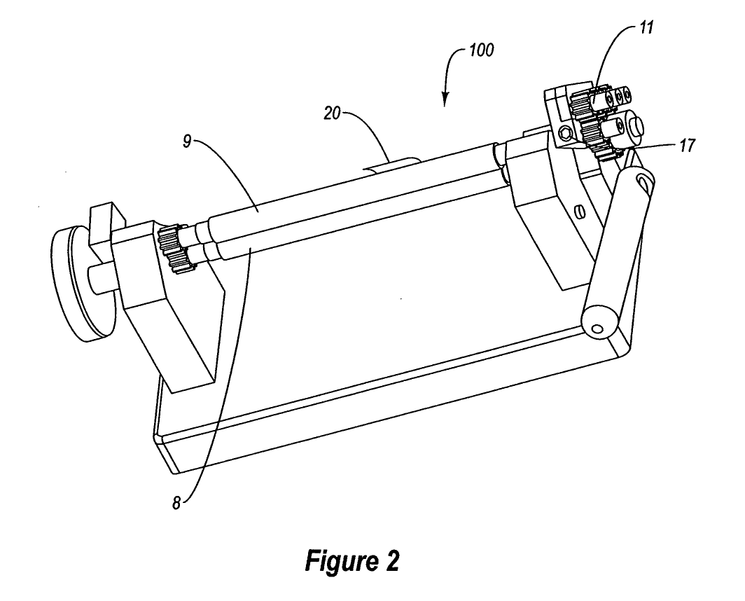

FIG. 2 shows the apparatus from the back allowing a closer look at the mechanical means for synchronizing the rotation of the stent with the means for applying the graft material, such as gear configuration 11. Also the connection port 17 for connection of a vacuum pump is shown.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced as within their scope.

1. An apparatus for applying a graft material to a stent, the apparatus comprising:
a mandrel adapted to receive the stent within the apparatus;
a forming roller lying axially parallel to and in contact with the stent, whereby rotation of the forming roller rotates the stent about its longitudinal axis;
mechanical means for applying a sheath of graft material to the stent as the stent is rotated about its axis; and
mechanical means for synchronising the rotation of the stent with the means for applying the graft material, the stent receiving mandrel being a hollow tube provided with small apertures in the region of the receiving area of the stent to allow a vacuum to be applied in order to temporarily affix a graft material sheath to the stent.

2. The apparatus according to claim 1, wherein the means for applying the sheath of graft material to the stent includes a pressure roller lying axially parallel to the stent and arranged to press the sheath of graft material against the stent.

3. The apparatus according to claim 1 wherein the mechanical means for synchronising the rotation of the stent with the means for applying the sheath of graft material to the stent is provided by intermediate gearing means in operative cooperation with the forming roller.

4. The apparatus according to claim 1 wherein the stent on the stent receiving mandrel itself operates as means for synchronising the rotation of the stent with the means for applying the sheath of graft material to the stent by contacting both means.

5. A method for manufacturing a stent graft comprising:
providing an apparatus comprising:
a hollow mandrel adapted to receive a stent, the mandrel having apertures in the region where the stent is imposed on the mandrel;
providing a stent;
imposing the stent on the mandrel;
applying a vacuum to the inside of the mandrel;
providing a sheath of a graft material of a size suitable to cover the stent in the desired area;
contacting a first portion of the graft material sheath with the outer surface of the stent mounted on the mandrel, thereby creating a tight temporary fit between the first end of the graft material and the stent by the drawing force of the vacuum; and
wrapping the graft material around the outer surface of the stent by rotation of the mandrel with the stent imposed thereon.

6. The method according to claim 5 further comprising affixing the wrapped graft material to the stent.

7. The method according to claim 6 wherein the wrapped graft material is affixed to the stent by the superimposition of a second stent over the first stent and the graft material.

8. The method according to claim 5, further comprising a final step of releasing the vacuum and removing the stent graft from the mandrel.

9. The method according to claim 6, further comprising a final step of releasing the vacuum and removing the stent graft from the mandrel.

10. The method according to claim 7, further comprising a final step of releasing the vacuum and removing the stent graft from the mandrel.

11. The apparatus according to claim 3 wherein the stent on the stent receiving mandrel itself operates as means for synchronising the rotation of the stent with the means for applying the sheath of graft material to the stent by contacting both means.

12. An apparatus for applying a graft material to a stent, the apparatus comprising:
a mandrel adapted to receive the stent within the apparatus;
a forming roller lying axially parallel to and in contact with the stent, whereby rotation of the forming roller rotates the stent about its longitudinal axis;
mechanical means for applying a sheath of graft material to the stent as the stent is rotated about its axis, the means for applying the sheath of graft material to the stent including a pressure roller lying axially parallel to the stent and arranged to press the sheath of graft material against the stent; and
mechanical means for synchronising the rotation of the stent with the means for applying the graft material, the stent receiving mandrel being a hollow tube provided with small apertures in the region of the receiving area of the stent to allow a vacuum to be applied in order to temporarily affix a graft material sheath to the stent.

13. The apparatus according to claim 12 wherein the mechanical means for synchronising the rotation of the stent with the means for applying the sheath of graft material to the stent is provided by intermediate gearing means in operative cooperation with the forming roller.

14. The apparatus according to claim 12 wherein the stent on the stent receiving mandrel itself operates as means for synchronising the rotation of the stent with the means for applying the sheath of graft material to the stent by contacting both means.

15. The apparatus according to claim 13 wherein the stent on the stent receiving mandrel itself operates as means for synchronising the rotation of the stent with the means for applying the sheath of graft material to the stent by contacting both means.
